(19) United States
(12) Patent Application Publication
(10) Pub. No.: US 2013/0327147 A1
(43) Pub. Date: Dec. 12, 2013

(54) Micromechanical Device for Measuring an Acceleration, a Pressure or the Like and a Corresponding Method

(71) Applicants: Ando Feyh, Palo Alto, CA (US); Christina Leinenbach, Karlsruhe (DE); Axel Franke, Ditzingen (DE); Gary O'Brien, Palo Alto, CA (US)

(72) Inventors: Ando Feyh, Palo Alto, CA (US); Christina Leinenbach, Karlsruhe (DE); Axel Franke, Ditzingen (DE); Gary O'Brien, Palo Alto, CA (US)

(73) Assignee: Robert Bosch GmbH, Stuttgart (DE)

(21) Appl. No.: 13/880,388

(22) PCT Filed: Sep. 19, 2011
(86) PCT No.: PCT/EP2011/066209

§ 371 Date: Aug. 23, 2013

(30) Foreign Application Priority Data
Oct. 20, 2010 (DE) 102010042687.3

(51) Int. Cl. G01P 15/125

(52) U.S. Cl. CPC G01P 15/125
USPC 73/514.32

(57) ABSTRACT

A micromechanical device measures an acceleration, a pressure or the like. It comprises a substrate having at least one fixed electrode, a seismic mass moveably arranged on the substrate, at least one ground electrode, which is arranged on the seismic mass, and resetting means for returning the seismic mass into an initial position, wherein the fixed electrode and the ground electrode are configured in one measurement plane for measuring an acceleration, a pressure or the like in the measurement plane, and wherein the fixed electrode and the ground electrode are configured for measuring an acceleration, pressure or the like acting on the seismic mass perpendicular to the measurement plane. The disclosure likewise relates to a corresponding method and a corresponding use.

The invention relates to a micromechanical device for measuring an acceleration, a pressure or the like and to a corresponding method and a corresponding use.

### PRIOR ART

Acceleration sensors are used in many areas. In recent times, for example, they have frequently been used in mobile telephones in order to detect a change in the attitude of the mobile telephone. If the mobile telephone is rotated in one plane by a user, for example, in order to be able to use the conventionally rectangular display transversely rather than longitudinally, this is detected by a corresponding acceleration sensor and forwarded to the operating system of the mobile telephone. The latter then calculates the changed attitude of the mobile telephone by using the acceleration measured by the acceleration sensor and matches the screen content to the calculated new attitude by means of a corresponding rotation of the screen content, so that a user can also see the screen content of the mobile telephone transversely in the desired way.

In addition, acceleration sensors are also used in hard drives in order to avoid damage to the hard drive. For instance, the acceleration sensor detects when the hard drive is inadvertently dropped by a user during the installation of the hard drive in a computer. The acceleration sensor then measures a free fall of the hard drive and the hard drive moves a read/write head of the hard drive into a secure parking position as a precaution, so that, in the case of the drop heights that usually occur, no damage is caused to the hard drive by the read/write head when said hard drive strikes the floor.

An acceleration can, for example, be determined by means of a capacitance change. For this purpose, interengaging finger electrodes are arranged in a common plane on a seismic mass and on a base. The seismic mass is mounted in this case such that it can move with respect to the base. The finger electrodes of the seismic mass and the corresponding finger electrodes of the base form capacitances between the respective electrodes. By using a change in the capacitances, the corresponding deflection of the seismic mass in the x or y direction in the plane of the finger electrodes can then be measured and therefore the force, acceleration, pressure, etc. acting on the seismic mass can be determined.

US 2005/0092107 A1 has disclosed a device for measuring an acceleration in two dimensions, a deflection in the third dimension being compensated for. The measurement of an acceleration in the x and/or y direction is carried out by means of interengaging finger electrodes of a seismic mass and a substrate. In order to compensate for an acceleration or force on the seismic mass perpendicular to the x-y plane, the finger electrodes of the substrate are arranged such that they can move perpendicular to the x-y plane. Then, if the seismic mass experiences a force with a component perpendicular to the x-y plane, the seismic mass is correspondingly displaced in the z direction, i.e. perpendicular to the x-y plane. The finger electrodes of the substrate, which are arranged such that they can move, are rotated in a corresponding way by the force acting in the z direction. Overall, therefore, the capacitance between the finger electrodes of the seismic mass and the finger electrodes of the substrate does not change on account of the likewise deflecting finger electrodes of the substrate. Therefore, a force component acting in the z direction is compensated for.

In order to be able to measure an acceleration perpendicular to the x-y plane, it is known to the applicant from a further reference to form the seismic mass as a rocker. An additional electrode can then be arranged on the seismic mass, parallel to the x-y plane on one side of the seismic mass, and likewise an additional electrode can be arranged in a corresponding way on the substrate, perpendicular to and at a distance from the x-y plane, so that these form a capacitance, which changes in the event of a deflection of the seismic mass perpendicular to the x-y plane. By using this change, the corresponding acceleration perpendicular to the x-y plane is then determined. However, this requires a complicated construction of the substrate and of the seismic mass and makes the corresponding acceleration sensor more expensive.

### DISCLOSURE OF THE INVENTION

The micromechanical device defined in claim 1 for measuring an acceleration, a pressure or the like comprises a substrate having at least one stationary electrode, a seismic mass arranged such that it can move on the substrate, at least one ground electrode, which is arranged on the seismic mass, wherein the stationary electrode and the ground electrode are configured in a measuring plane to measure an acceleration, a pressure or the like in the measuring plane, and wherein the stationary electrode and the ground electrode are configured to measure an acceleration, a pressure or the like acting on the seismic mass perpendicular to the measuring plane.

The method defined in claim 9 for measuring an acceleration, a pressure or the like, in particular suitable to be implemented by a device as claimed in at least one of claims 1 to 7, comprises the steps of arrangement of at least one stationary electrode on a substrate and at least one ground electrode on a seismic mass arranged such that it can move on the substrate, wherein the stationary electrode and the ground electrode interact to measure an acceleration, a pressure or the like in a measuring plane, action of an external force on a seismic mass perpendicular to the measuring plane, deflection of the seismic mass on account of the external force in a direction perpendicular to the measuring plane, measurement of a change in a capacitance between the at least one ground electrode and the at least one stationary electrode, and determination of the acceleration, the pressure or the like by using the measured change in the capacitance.

In claim 10, a use of a device as claimed in at least one of claims 1 to 8 for measuring an acceleration and/or a pressure is defined.

### ADVANTAGES OF THE INVENTION

The micromechanical device defined in claim 1 for measuring an acceleration, a pressure or the like, and the corresponding method defined in claim 8 have the advantages that electrodes already arranged, which measure an acceleration or a pressure in an x-y plane, can therefore also be used in a simple way to measure an acceleration, a pressure or the like in a direction perpendicular to the x-y plane. As a result, additional electrodes which measure an acceleration in a z direction, i.e. a direction perpendicular to the x-y plane, are dispensed with. At the same time, the device can also be produced simply and the method can be carried out simply, since the complicated arrangement of additional electrodes on the substrate and on the seismic mass and the shaping of the substrate z direction as well can be dispensed with completely.

Further features and advantages of the invention are described following subclaims.

According to an advantageous development, the seismic mass is formed such that it can rotate about an axis of rotation, wherein the axis of rotation is arranged in the measuring plane. The advantage achieved thereby is that, firstly, complicated resetting of the seismic mass into an initial position can therefore be dispensed with, since appropriate means can be provided centrally. Secondly, a simple option for deflection perpendicular to the measuring plane is therefore also provided.

According to a further advantageous development, the stationary electrode and ground electrode are configured to form at least two capacitances between stationary electrode and ground electrode. The advantage achieved in this case is that a direction of the deflection perpendicular to the x-y plane can therefore be determined in a reliable way. In the event of an appropriate deflection, the magnitude of the first capacitance decreases, whereas the magnitude of the second capacitance increases. If a deflection takes place in the opposite direction, the magnitude of the first capacitance increases, whereas the magnitude of the second capacitance increases.

According to a further advantageous development of the invention, the stationary electrode comprises at least two metallic first regions, and the ground electrode comprises at least one metallic second region, wherein the first and second metallic regions interact to form the at least two capacitances. Therefore, in a simple and inexpensive way, the formation of two capacitances for the detection of the direction of the deflection of the seismic mass perpendicular to the measuring plane is made possible. If the first and/or second metallic regions are arranged one above another on the respective electrode in the direction perpendicular to the measuring plane, the measurement of the force, the acceleration, the pressure or the like can be carried out still more reliably, and at the same time the direction of the deflection perpendicular to the x-y plane can be determined.

According to a further advantageous development of the invention, on opposite sides of the seismic mass in relation to the axis of rotation, in each case at least one ground electrode is arranged on the seismic mass and in each case at least one stationary electrode is arranged on the substrate. In this way, the reliability of a measurement of a pressure, an acceleration or the like is increased further, since a plurality of electrodes is then available on various sides to measure a deflection in the z direction.

According to a further advantageous development of the invention, in each case the upper first regions of a first stationary electrode are respectively interconnected with the lower first regions of a second stationary electrode for measuring an acceleration, a pressure or the like. Such an arrangement permits a considerable reduction in the transverse sensitivity of the device. If the seismic mass is deflected in the z direction, then, if it is mounted such that it can rotate about a central axis, it experiences a positive deflection on one side of the axis of rotation and a corresponding negative deflection on the other side of the axis of rotation perpendicular to the measuring plane. The positive and negative deflection can then be determined and, by means of differentiation of the respective measured changes in the capacitances, possible interference can be eliminated.

According to a further advantageous development of the invention, the first and/or second metallic regions each comprise at least two metal layers arranged one above another, which are connected to one another electrically, in particular by means of through contacts. The advantage here is that conventional CMOS production methods can therefore be used, which are able to provide appropriate metallic regions or metal layers, firstly inexpensively and secondly reliably.

According to a further advantageous development of the invention, the stationary electrode and/or the ground electrode comprise/s at least one deposited, in particular dielectric, layer. The advantage achieved here is that the electrodes can therefore be produced in a simple and inexpensive way and, at the same time, the metallic regions can be insulated from one another and also the metal layers forming the metallic regions can be insulated from one another.

### BRIEF DESCRIPTION OF THE DRAWINGS

Further features and advantages of the invention can be gathered from the following description of exemplary embodiments. Here:

FIG. 1 shows a stationary electrode and a ground electrode of a device according to one embodiment of the present invention;

FIG. 2 shows a schematic representation of a device according to the embodiment of FIG. 1 in plan view of an x-y plane;

FIG. 3 shows stationary electrodes and ground electrodes of a device according to the embodiment of FIG. 1; and

FIG. 4 shows steps of a method according to one embodiment of the present invention.

### EMBODIMENTS OF THE INVENTION

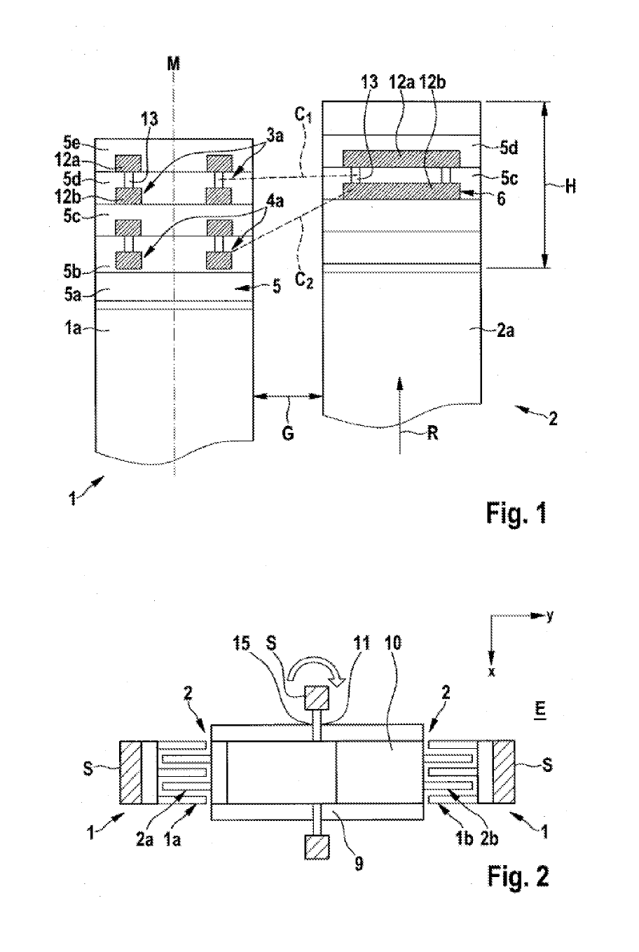

FIG. 1 shows a stationary electrode and a ground electrode of a device according to one embodiment of the present invention.

In FIG. 1, designation 1 designates a stationary electrode, which is arranged on a substrate S (not shown in FIG. 1). The stationary electrode 1 is configured substantially as a finger electrode 1a and is illustrated in cross section in FIG. 1. In the end region of the stationary electrode 1, the latter has layers 5a-5e of dielectrics 5 arranged one above another. Five layers 5a-5e are shown in FIG. 1. The first layer 5a from bottom to top according to FIG. 1 comprises only one dielectric 5. The second layer 5b arranged over the first layer 5a comprises, in the lower region on the left and right of an axis of symmetry M of the stationary electrode 1, a metal layer 12b which is connected via a through contact 13 to a metal layer 12a of the adjacent third layer 5c. This metal layer structure comprising metal layers 12a, 12b and through contact 13 is respectively arranged in the region both of the left-hand and also of the right-hand edge of the stationary electrode 1 and symmetrically with respect to the axis of symmetry M. The third layer 5c—as explained above—comprises only the lower metal layer 12a.

Further layers 5d, 5e, which correspond substantially in structure to the first and second layer 5a, 5b, are stacked on the third layer 5c. In this way, an upper first and a lower first metallic region 3a, 4a are arranged on the stationary electrode 1, respectively on the left and right of the axis of symmetry M, each comprising two metal layers 12a, 12b which are connected by means of at least one through contact 13.

On the right in FIG. 1, the ground electrode 2, which is arranged on a seismic mass 10 (not shown in FIG. 1), is now shown in cross section. This is likewise formed as a finger electrode 2a. The seismic mass 10 and therefore the ground electrode 2 is arranged such that it can move in the vertical direction relative to the stationary electrode 1 in the direction R according to FIG. 1. The structure of the ground electrode 2 corresponds substantially to the structure of the stationary electrode 1 according to FIG. 1. In contrast to the stationary electrode 1, however, only two metal layers 12a, 12b are arranged in the third and fourth layer 5c, 5d. These are once more connected to one another via through contacts 13. In this way, by means of the two metal layers 12a, 12b and the through contact 13 connecting the latter, a second metallic region 6 is formed.

Two capacitances C₁, C₂ are formed between the second metallic region 6 of the ground electrode 2 and the two first metallic regions 3a, 4a of the stationary electrode 1. The first capacitance C₁ is formed between the upper metallic first region 3a and the second metallic region 6, the second capacitance C₂ is formed between the lower first metallic region 4a and the second metallic region 6 of the ground electrode 2. If then, as indicated in FIG. 1, the ground electrode 2 is displaced or deflected upward in the direction R with respect to the stationary electrode 1, the capacitance C₁ rises on account of the distance between the upper first metallic region 3a of the stationary electrode 1 and the second metallic region 6 of the ground electrode 2 becoming smaller, whereas the capacitance C₂ decreases on account of the distance between the lower first metallic region 4a of the stationary electrode 1 and the second metallic region 6 of the ground electrode 2 becoming larger. In an initial position, the stationary electrode 1 and the ground electrode 2 are arranged in such a way that the respective capacitances C₁ and C₂ are equal: C₁=C₂.

Both the stationary electrode 1 and/or the ground electrode 2 comprise/s layers 5a-5e arranged one above another, as explained above. This stack of layers 5a-5e can be produced, for example, by depositing the individual layers 5a-5e after and on one another. Furthermore, the stationary electrode 1 and/or the ground electrode 2 can also comprise a region of a semiconductor substrate, for example silicon.

FIG. 2 shows a schematic representation of a device according to the embodiment of FIG. 1 in plan view of an x-y plane.

In FIG. 2, designation S designates a substrate on which a plurality of electrode fingers 1a of a stationary electrode 1 is arranged. Between the respective electrode fingers 1a, corresponding electrode fingers 2a of a ground electrode 2 engage which, according to FIG. 2, are arranged on the left-hand side of a housing 9 for a seismic mass 10. On the right-hand side of the housing 9 according to FIG. 2, there are arranged corresponding electrode fingers 2b, which engage in electrode fingers 1b of the substrate S. The respectively adjacent electrode fingers 1a, 2a and 1b, 2b form respectively corresponding capacitances C₁-C₄, the change in which during a relative movement of the electrode fingers 1a, 1b and 2a, 2b in relation to one another is used to measure the force, acceleration, etc. acting on the seismic mass 10.

The housing 9 for the seismic mass 10 is mounted such that it can rotate about an axis of rotation 11, the axis of rotation being arranged in the x-y measuring plane E and on the substrate S. The seismic mass 10 is arranged asymmetrically in the housing 9 and/or with respect to the axis of rotation 11. On the right-hand side according to FIG. 1, the housing 9 has the seismic mass 10, whereas no seismic mass is arranged on the left-hand side in the housing 9. Furthermore, a resetting means 15 in the form of a torsion spring is arranged, in order, if appropriate, to set the seismic mass 10 back into its initial position from a deflection perpendicular to the x-y measuring plane.

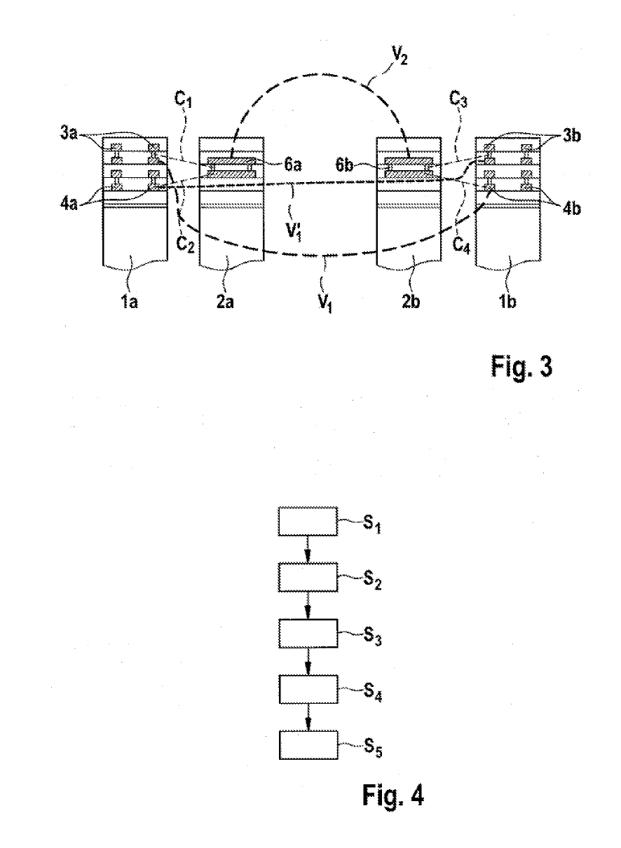

FIG. 3 shows stationary electrodes and ground electrodes of a device according to the embodiment of FIG. 1.

In FIG. 3, an interconnection V₁, V₂, V_{1′} of the first and second metallic regions 3a, 3b, 4a, 4b, 6a, 6b of the stationary electrode fingers 1a and 1b and also of the ground electrode fingers 2a, 2b is shown in schematic form. In FIG. 3, the stationary electrode 1a, the ground electrode 2a, the ground electrode 2b and the stationary electrode 1b are arranged from left to right. The stationary electrode 1b has a corresponding structure as described in FIG. 1, i.e. an upper first metallic region 3a and a lower first metallic region 4a on the right-hand side of the electrode 1a. Accordingly, the stationary electrode 1b has, on its left-hand side, i.e. on its side facing the second ground electrode 2b, an upper first metallic region 3b and a lower first metallic region 4b. For the purpose of differential evaluation of capacitance changes of capacitances C₁-C₄, the respective upper first metallic region 3a, 3b of the stationary electrode 1a is interconnected with the respective lower first metallic region 4a, 4b of the opposite stationary electrode 1b. These interconnections are illustrated in FIG. 3 as broken lines and designated by the designations V₁ and V_{1′}. The second metallic regions 6a and 6b of the ground electrodes 2a, 2b are likewise interconnected with each other, indicated by the broken line V₂ in FIG. 3. In this way, a differential evaluation of the change in the respective capacitances C₁-C₄ is possible.

If an external force acts on the seismic mass 10, the ground electrode 2a is displaced upward, for example, and in a corresponding way the ground electrode 2b is displaced downward. In the process, the capacitance C₁ increases and so does the capacitance C₄, since the respective distance between the first and second metallic regions 3a, 4b, 6 becomes smaller. At the same time, the capacitance C₂ and C₃ decreases, since the distance between the corresponding first and second metallic regions 3b, 4a, 6 becomes larger. By means of the interconnection V₁, V_{1′}, V₂, the formation of a difference between the increasing capacitances C₁, C₄ and the decreasing capacitances C₂, C₃ is possible; this increases the measurement accuracy.

The respective thicknesses of the dielectric layers 5a-5e of the stationary electrode 1 and of the ground electrode 2 are at most 10 μm, preferably less than 5 μm, advantageously between 1 and 2 μm. The first and second metallic regions 3a, 3b, 4a, 4b substantially have a thickness less than 2.5 μm, preferably less than 1.5 μm, in particular between 0.5 and 1 μm. The distance G between a stationary electrode 1 and a ground electrode 2 is less than 5 μm, preferably between 1 and 3 μm. A metallic region 3a, 3b, 4a, 4b has an extent perpendicular to the drawing plane according to FIG. 1 between 10 μm and 500 μm, preferably between 50 μm and 200 μm. An overall height H of the dielectric layers 5 and the metallic regions 3a, 3b, 4a, 4b, 6 is between 3 and 10 μm, preferably between 4 and 8 μm.

FIG. 4 shows steps of a method according to one embodiment of the present invention.

The method for measuring an acceleration, a pressure or the like, in particular suitable to be implemented by a device as claimed in at least one of claims 1-7, according to FIG. 4 comprises the steps: arrangement S₁ of at least one stationary electrode 1 on a substrate S and at least one ground electrode 2 on a seismic mass 10 arranged such that it can move on the substrate S, wherein the stationary electrode 1 and the ground electrode 2 interact to measure an acceleration, a pressure or the like in a measuring plane E, action S₂ of an external force on a seismic mass perpendicular to the measuring plane, deflection S₃ of the seismic mass 10 on account of the external force in a direction R perpendicular to the measuring plane E, measurement S₄ of a change in a capacitance C₁, C₂ between the at least one ground electrode 2 and the at least one stationary electrode 1, and determination S₅ of the acceleration, the pressure or the like by using the measured change in the capacitance C₁, C₂.

Although the present invention has been described above by using preferred exemplary embodiments, it is not restricted thereto but can be modified in numerous ways.

1. A micromechanical device for measuring an acceleration, a pressure or the like, comprising:
a substrate having at least one stationary electrode;
a seismic mass configured to move on the substrate; and
at least one ground electrode supported on the seismic mass,
wherein the at least one stationary electrode and the at least one ground electrode are configured in a measuring plane to measure an acceleration, a pressure or the like in the measuring plane, and
wherein the at least one stationary electrode and the at least one ground electrode are configured to measure an acceleration, a pressure or the like acting on the seismic mass perpendicular to the measuring plane.

2. The micromechanical device as claimed in claim 1, wherein:
the seismic mass is configured to rotate about an axis of rotation, and
the axis of rotation is defined in the measuring plane.

3. The micromechanical device as claimed in claim 2, wherein the at least one stationary electrode and the at least one ground electrode are configured to form define at least two capacitances between the at least one stationary electrode and the at least one ground electrode.

4. The micromechanical device as claimed in claim 3, wherein:
the at least one stationary electrode includes at least two metallic first regions,
the at least one ground electrode includes at least one metallic second region, and
the at least two metallic first regions and the at least one metallic second region interact to define the at least two capacitances.

5. The micromechanical device as claimed in claim 4, wherein:
the seismic mass has a first side and a second side opposite the first side in relation to the axis of rotation,
at least one first ground electrode of the at least one ground electrode is supported on the first side of the seismic mass, and at least one second ground electrode of the at least one ground electrode is supported on the second side of the seismic mass, and
at least one first stationary electrode of the at least one stationary electrode is supported on a first side of the substrate corresponding to the first side of the seismic mass and at least one second stationary electrode of the at least one stationary electrode is supported on a second side of the substrate corresponding to the second side of the seismic mass.

6. The micromechanical device as claimed in claim 5, wherein:
upper first metallic regions of the at least one first stationary electrode are respectively interconnected with lower first metallic regions of the at least one second stationary electrode for measuring an acceleration, a pressure or the like.

7. The micromechanical device as claimed in claim 4, wherein:
at least one of the first and second metallic regions include at least two metal layers arranged one above another, and
the two metal layers are connected to one another electrically by through contacts.

8. The micromechanical device as claimed in claim 1, wherein:
at least one of the at least one stationary electrode and the at least one ground electrode includes at least one deposited dielectric layer.

9. A method for measuring an acceleration, a pressure or the like, comprising:
arranging at least one stationary electrode on a substrate and at least one ground electrode on a seismic mass such that the seismic mass is movable on the substrate, wherein the at least one stationary electrode and the at least one ground electrode are configured to interact to measure an acceleration, a pressure or the like in a measuring plane;
subjecting the seismic mass to an external force perpendicular to the measuring plane;
deflecting the seismic mass on account of the external force in a direction perpendicular to the measuring plane;
measuring a change in a capacitance between the at least one ground electrode and the at least one stationary electrode; and
determining the acceleration, the pressure or the like by using the measured change in the capacitance.

10. (canceled)
